(19) United States
(12) Patent Application Publication
(10) Pub. No.: US 2004/0078221 A1
(43) Pub. Date: Apr. 22, 2004

(54) MediCAD Chinese medical system

(76) Inventors: Yi-Yun Chen, Shanghai (CN); Ming-Yan Dong, Shanghai (CN); Da-Qian Chen, Shanghai (CN); Zhang-zhong Zhao, Shanghai (CN)

Correspondence Address: Raymond Y. Chan, Suite 128, 108 N. Ynez Avenue, Monterey Park, CA, 91754, US

(21) Appl. No.: 10/336,391

(22) Filed: Jan. 6, 2003

Related U.S. Application Data
(60) Provisional application No. 60/395,856, filed on Jul. 16, 2002.

(51) Int. Cl. G06F 17/60

(52) U.S. Cl. 705/2

(57) ABSTRACT

A Chinese medical system comprises a signal input device for entering information, an input signal generated in response to the signal input device, a database system comprising a diagnostic database storing a diagnostic information of Chinese diagnostic information and a matching analyzer analyzing the input signal and matching the input signal with the diagnostic information, a diagnostic output signal generated in response to the matching analyzer of the database system, a responsive system comprising an action database storing a treatment methods information, a retriever retrieving the treatment methods information in response to the diagnostic output signal to generate a retriever signal, a signal transmitter receiving the diagnostic output signal and transmitting the diagnostic output signal to the retriever, and a responsive signal generator generating a responsive signal from gathering and organizing the retriever signal; and an output device in response to the responsive signal displaying the corresponding treatment methods information of the action database.

### CROSS REFERENCE OF RELATED APPLICATION

This is a regular application of a provisional application, application No. 60/395,856, filed Jul. 16, 2002.

### BACKGROUND OF THE PRESENT INVENTION

1. Field of Invention

The present invention relates to MediCAD Chinese Medical System, and more particularly to a MediCAD Chinese Medical System that provides an information database for assisting diagnosis.

2. Description of Related Arts

Traditional Chinese medicine is broadly used in the Chinese society and increasingly accepted as alternative therapies in foreign countries. Traditional Chinese medicine is highly emphasized on the past experience of our ancestors and the medical theory, and the medical hypothesis or the medical application information are collectively recorded in many different books, journals, dictionaries or encyclopedia. However, there is no one existing organized or standardized informative database for the Traditional Chinese medicine. It is very difficult to have a complete collection of Chinese medicine information for study, research, or application purposes. Therefore, the research and development and the applications of the traditional Chinese medicine are limited.

Applications of Chinese medicine include medical diagnosis and medical treatment by practitioners. The accuracy of medical diagnosis is highly depended on the practitioner's experience and available information. Since there is no one existing organized and standardized informative database for medical diagnosis of Chinese medicine, the accuracy of medical diagnosis is adversely affected. If there is a way to retrieve information during medical diagnosis, the accuracy of diagnosis will be greatly increased and the effectiveness and efficiency of diagnosis will be enhanced.

The basis of Chinese medicine is to restore the body balance of human body. It can be the balance of gold, wood, water, fire, and earth. And there is usually not one and only one method of restoring the balance of our bodies. Different ways of treatment may come up to the same result and the most appropriate and suitable method of treatment depends on the experience of the practitioners. Therefore, if there is a system that can provide different methods of treatments according to a corresponding diagnosis result, the selection of treatment method of practitioners will be made more easily and effectively. Furthermore, the relatively inexperience practitioners will build up their knowledge and professionalism through the Chinese medical system and the development of the Chinese medicine may be speed up dramatically as the inexperience practitioners can have more chance of learning treatment methods of different practitioners. This kind of intra-communication will greatly benefit the development of the Traditional Chinese medicine and will ultimately benefit our human society.

Comparisons and researches have been carried out between western medicine and Chinese medicine. Due to the nonsystematic records of the Chinese medicine, it is very difficult to study the difference and the same of the two kind of medical theories. Besides, it poses great difficulty for non-Chinese people to learn or understand the Chinese medicine. Therefore, if there is a systematic informative database for the Chinese medicine, which is capable of providing a language selection, studies of the difference and the same of the western medicine and Chinese medicine will be made possible for non-Chinese people and Chinese people. Thus, studies will be more thorough and objective in different directions and our human society will ultimately have a great step towards medical studies.

### SUMMARY OF THE PRESENT INVENTION

It is an object of the present invention to provide a Chinese medical system for providing a standardized and organized information database.

It is another object of the present invention to provide a Chinese medical system for providing a standardized and organized information database for assisting diagnosis for practitioners.

It is another object of the present invention to provide a Chinese medical system, wherein the Chinese medical system provides an information database for suggesting a predetermined therapies method for a corresponding diagnosis result.

It is anther object of the present invention to provide a Chinese medical system, such that practitioners are capable of retrieving information from the database effectively and efficiency.

It is another object of the present invention to provide a Chinese medical system, wherein the Chinese medical system provides an information database for researches and studies.

It is another object of the present invention to provide a Chinese medical system, wherein the Chinese medical system provides a discussion section such that practitioners can exchange information through the Chinese medical system.

Accordingly, in order to accomplish the above objects, the present invention provides a Chinese medical system comprising:

a signal input device for entering information;

an input signal generated in response to the signal input device;

a database system comprising a diagnostic database storing a diagnostic information of Chinese diagnostic information and a matching analyzer analyzing the input signal and matching the input signal with the diagnostic information;

a diagnostic output signal generated in response to the matching analyzer of the database system;

a responsive system comprising an action database storing a treatment methods information, a retriever retrieving the treatment methods information in response to the diagnostic output signal to generate a retriever signal, a signal transmitter receiving the diagnostic output signal and transmitting the diagnostic output signal to the retriever, and a responsive signal generator generating a responsive signal from gathering and organizing the retriever signal; and

an output device in response to the responsive signal displaying the corresponding treatment methods information of the action database.

### BRIEF DESCRIPTION OF THE DRAWINGS

FIG. 1 is a block diagram of a Chinese medical system according to a first preferred embodiment of the present invention.

FIG. 2 is a block diagram of a Chinese medical system according to the first preferred embodiment of the present invention

FIG. 3 is a block diagram of a Chinese medical system according to the first preferred embodiment of the present invention, wherein the Chinese medical system is link to a predetermined Host system.

FIG. 4 is a block diagram of a Chinese medical system according to the first preferred embodiment of the present invention, wherein the Chinese medical system is link to a language system.

FIG. 5 is a block diagram of a Chinese medical system according to the first preferred embodiment of the present invention, wherein the Chinese medical system comprises a visual and audio display as an output.

FIG. 6 is a block diagram of a Chinese medical system according to second preferred embodiment of the present invention.

FIG. 7 is a flow chart of a method of using a Chinese medical system for diagnosis.

### DETAILED DESCRIPTION OF THE PREFERRED EMBODIMENT

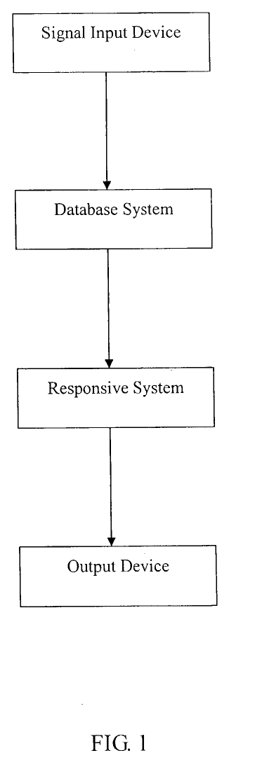

Referring to FIG. 1 of the drawings, a box diagram of a Chinese medical system according to the first preferred embodiment is illustrated. The Chinese medical system comprises a signal input device 10, a database system 20, a responsive system 30 and an output device 40.

The signal input device 10 is used for entering information. The signal input device 10 can be of any kinds, such as a keyboard, a mouse, an audio transmitter, a movement sensor, a thermo-sensor, a pulse sensor.

An input signal S1 is then generated in response to the information entered to the signal input device 10.

The database system 20 is communicated with the signal input device, wherein the database system 20 stores a Chinese diagnostic information and matches the input signal S1 with the Chinese diagnostic information. A diagnostic output signal S2 is then generated from the database system 20. The Chinese diagnostic information stored may include information of official standards of Chinese medicine, official standards of international western medicine, rules and regulations of Chinese medicine, common diagnostic methods of Chinese medicine, official encyclopedia of Chinese medicine, and official gazette of Chinese medicine.

The database system 20 may further comprise means for expanding the stored information, such as an extra memory or an extra plug-in connector adapted for receiving and storing any additional information or for updating the stored information of the database system.

The responsive system 30 communicated with the database system 20 stores a treatment methods information, which includes information from official standards of Chinese medicine, official standards of international western medicine, rules and regulations of Chinese medicine, common diagnostic methods of Chinese medicine, official encyclopedia of Chinese medicine, and official gazette of Chinese medicine.

The responsive system 30 receives the diagnostic output signal S2 from the database system 20, analyses the diagnostic output signal S2 and retrieves the treatment methods information to generate a responsive signal S4.

The responsive system 30 may further comprise a second means for expanding the responsive system, such as an extra memory or an extra plug in connector adapted for receiving and storing any additional information or for updating the treatment methods information of the responsive system 30.

The output device 40 receives the responsive signal S4 from the responsive system 30 and display the treatment methods information in response to the responsive signal S4. The output device 40 may be of any forms, such as a monitor, a printer, a memory storage like CD or floppy disk, or a speaker. Furthermore, the output device 40 may also comprise an extendable link which is capable of communicating to a second Chinese medical system or communicating to other systems, such as a host system or a hospital system to facilitate different uses.

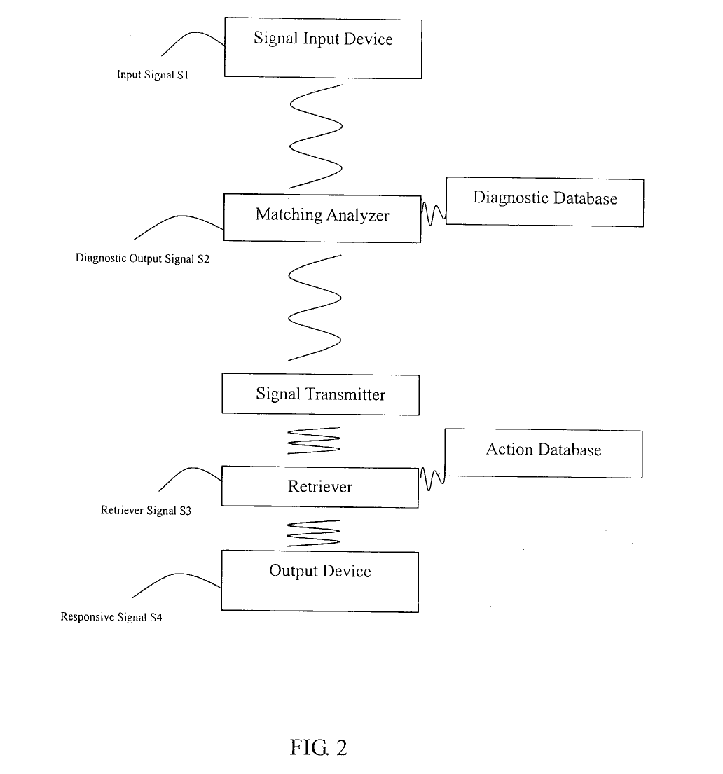

Referring to FIG. 2 of the drawings, a detailed box diagram of a Chinese medical system according to a first preferred embodiment is illustrated. The Chinese medical system comprises a signal input device 10, a database system 20, a responsive system 30 and an output device 40.

The signal input device 10 is used for entering information. The signal input device 10 can be of any kinds, such as a keyboard, a mouse, an audio transmitter, a movement sensor, a thermo-sensor, a pulse sensor.

An input signal S1 is then generated in response to the information entered to the signal input device 10.

The database system 20 communicating with the signal input device 10 comprises a diagnostic database 21 storing a diagnostic information of Chinese diagnostic information and a matching analyzer 22 analyzing the input signal S1 and matching the input signal S1 with the diagnostic information to generate a diagnostic output signal S2. The diagnostic database 21 may include information of official standards of Chinese medicine, official standards of international western medicine, rules and regulations of Chinese medicine, common diagnostic methods of Chinese medicine, official encyclopedia of Chinese medicine, and official gazette of Chinese medicine.

The database system 20 may further comprise means for expanding the database system, such as an extra memory or an extra plug-in connector adapted for receiving and storing any additional information or for updating the diagnostic information of the diagnostic database 21 of the database system 20.

The responsive system 30 comprises an action database 31, a signal transmitter 32, a retriever 33, and a responsive signal generator 34. The action database 31 stores a treatment methods information, which includes information from official standards of Chinese medicine, official standards of international western medicine rules and regulations of Chinese medicine, common diagnostic methods of Chinese medicine, official encyclopedia of Chinese medicine, and official gazette of Chinese medicine.

The signal transmitter 32 communicating with the database system 20 is adapted for receiving the diagnostic output signal S2 and then transmitting the diagnostic output signal S2 to the retriever 33.

The retriever 33 of the responsive system 30 is responsible for retrieving the treatment methods information in response to the diagnostic output signal S2 to generate a retriever signal S3.

The responsive signal generator 34 then generates a responsive signal S4 from gathering and organizing the retriever signal S3.

The responsive system 30 may further comprise a second means for expanding the database system, such as an extra memory or extra plug-in connector adapted for receiving and storing any additional information or for updating the treatment method information of the action database 31.

The output device 40 communicates with the responsive system 30, receiving the responsive signal S4 and displaying the corresponding treatment methods information of the action database 31. The output device 40 may be of any forms, such as a monitor, a printer, a memory storage like CD or floppy disk, or a speaker. Furthermore, the output device 40 may also comprise an extendable link which is capable of communicating to a second Chinese medical system or communicating to other systems, such as a host system or a hospital system to facilitate different uses.

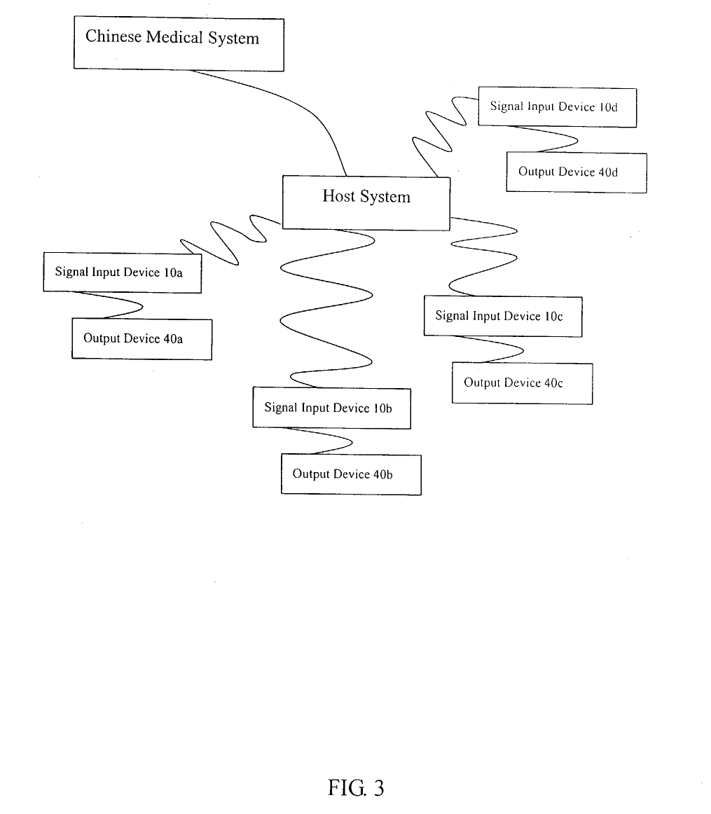

Referring to FIG. 3 of the drawings, a Chinese medical system linking to a predetermined host system is illustrated. The host system may be a central networking system or a server system.

When the Chinese medicine is linked to a central networking system, different users at different locations may communicate with each other. For example, an user A may send questions along with the diagnostic output signal S2, the retriever signal S3 and the responsive signal S4 to an user B. Then, user B can involve in having discussion with the user A and assist in coming up with the best treatment methods.

Furthermore, when the Chinese medical system is used in a building, it is possible to share the Chinese medical system for multi-users. The Chinese medical system may further comprise a signal input device system and a corresponding output device system. The signal input device system comprises signal input device 10a, 10b, 10c, 10d . . . and the output device system comprises output device 40a, 40b, 40c, 40d . . . correspondingly. Therefore, different users can use one corresponding signal input device and output device for access to the Chinese medical system. Intra-networking or inter-networking is both possible for the Chinese medical system.

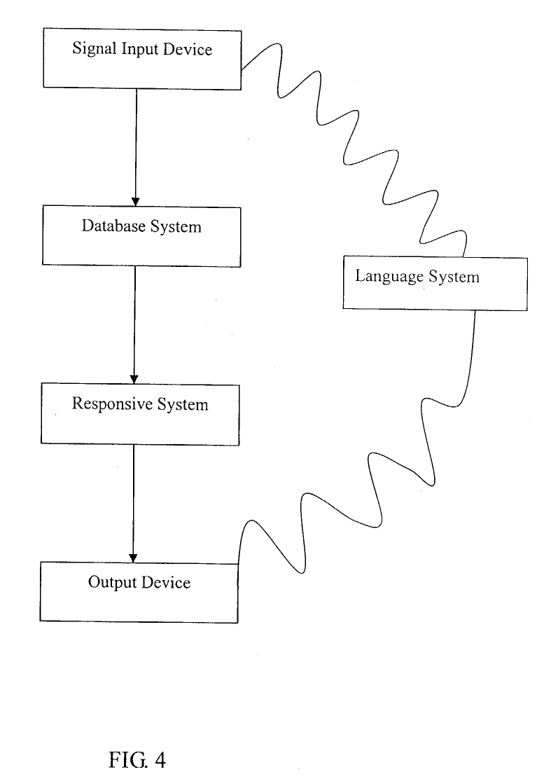

Referring to FIG. 4 of the drawings, a Chinese medical system of the present invention is illustrated, wherein the Chinese medical system is connected to a language system 50.

The language system 50 comprises at least two language databases, such as a Chinese language database D1 and an English database D2. When the information entered is in the form of English, the language system 50 transforms the information entered into a predetermined default language of the Chinese medical system, for example, Chinese in this case. Then, the Chinese medical system is capable to proceed and generates a responsive signal S4.

Then, the responsive signal S4 is sent to the language system 50 for translating the default language to English such that even an English user may use the Chinese medical system when the default language of the system is in Chinese. Different language systems maybe incorporated into the language system 50 for different language users.

Furthermore, the language system 50 further comprises a reference database such that explanation of words used is included in the system.

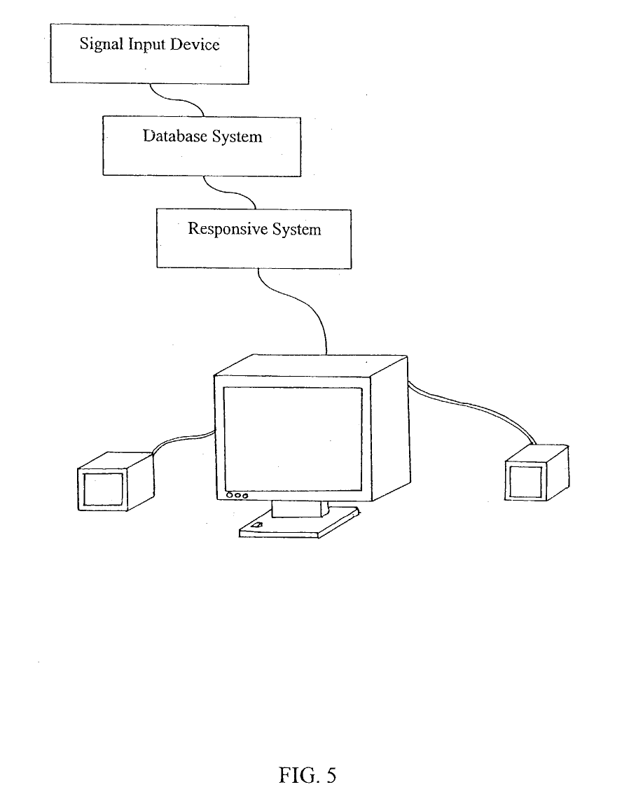

Referring to FIG. 5 of the drawings, a Chinese medical system is illustrated and the Chinese medical system is connected to a visual and audio display as an output device 40.

The visual and audio display is a screen incorporated with a speaker. Therefore, when an user can see and listen to the result. The visual and audio display may also be used to present an animation such that the treatment methods can be shown clearly and systematically with a predetermined sequenced steps.

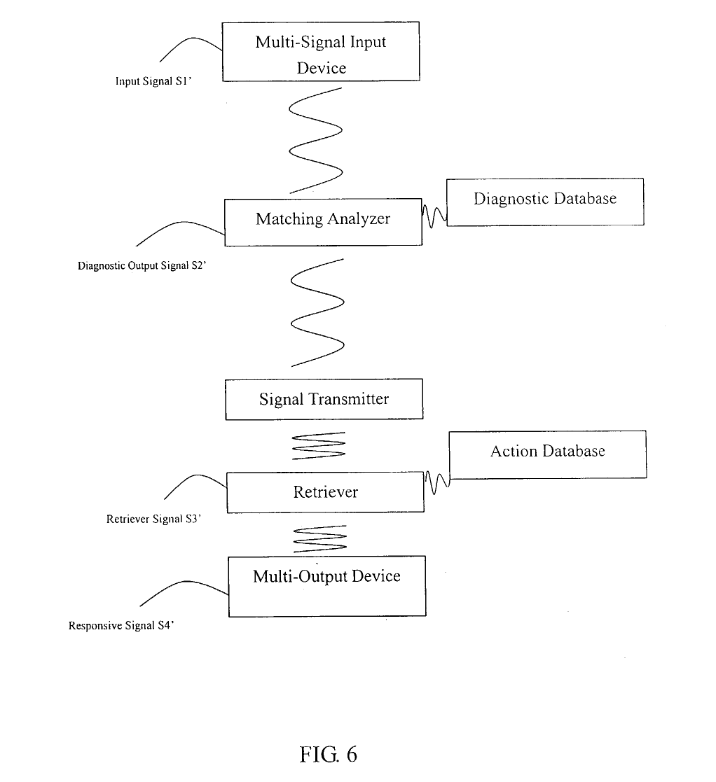

Referring to FIG. 6 of the drawings, a Chinese medical system according to a second preferred embodiment is illustrated. The Chinese medical system comprises a multi-signal input device 10′, a database system 20′, a responsive system 30′ and a multi-output device 40′.

The multi-signal input device 10′ is used for entering information. The signal input device 10 can be of any kinds, such as a keyboard, a mouse, an audio transmitter, a movement sensor, a thermo-sensor, a pulse sensor. For example, a palm-shaped sensor consisting of a thermo-sensor and a pulse sensor is illustrated in FIG. 6.

Then, an input signal S1′ is generated in response to the multi-signal input device 10′.

The database system 20′ communicating with the multi-signal input device 10′ comprises a diagnostic database 21′ storing a diagnostic information of Chinese diagnostic information and a matching analyzer 22′ analyzing the input signal S1′ and matching the input signal S1′ with the diagnostic information to generate a diagnostic output signal S2′. The diagnostic database 21′ may include information of official standards of Chinese medicine, official standards of international western medicine, rules and regulations of Chinese medicine, common diagnostic methods of Chinese medicine, official encyclopedia of Chinese medicine, and official gazette of Chinese medicine.

The database system 20′ may further comprise means for expanding the database system, such as an extra memory or an extra plug-in connector adapted for receiving and storing any additional information or for updating the diagnostic information of the diagnostic database 21′ of the database system 20′.

The responsive system 30′ comprises an action database 31′, a signal transmitter 32′, a retriever 33′, and a responsive signal generator 34′. The action database 31′ stores a treatment methods information, which includes information from official standards of Chinese medicine, official standards of international western medicine, rules and regulations of Chinese medicine, common diagnostic methods of Chinese medicine, official encyclopedia of Chinese medicine, and official gazette of Chinese medicine.

The signal transmitter 32′ communicating with the database system 20′ is adapted for receiving the diagnostic output signal S2′ and then transmitting the diagnostic output signal S2′ to the retriever 33′.

The retriever 33′ of the responsive system 30′ is responsible for retrieving the treatment methods information. A retriever signal S3′ is generated in response to the diagnostic output signal S2′ and accordingly the treatment methods information is retrieved.

The responsive signal generator 34′ then generates a responsive signal S4′ from gathering and organizing the retriever signal S3′.

The responsive system 30′ may further comprise a second means for expanding the database system, such as an extra memory or an extra plug-in connector adapted for receiving and storing any additional information or for updating the treatment method information of the action database 31′.

The multi-output device 40′ communicates with the responsive system 30′, receiving the responsive signal S4 and displaying the corresponding treatment methods information of the action database 31′. The output device 40′ may be of any forms, such as a monitor, a screen, a printer, a memory storage like CD or floppy disk, or a speaker. For example, a screen and a printer are illustrated in FIG. 6.

Furthermore, the output device 40′ may also comprise an extendable link which is capable of communicating to a second Chinese medical system or communicating to other systems, such as a host system or a hospital system to facilitate different uses.

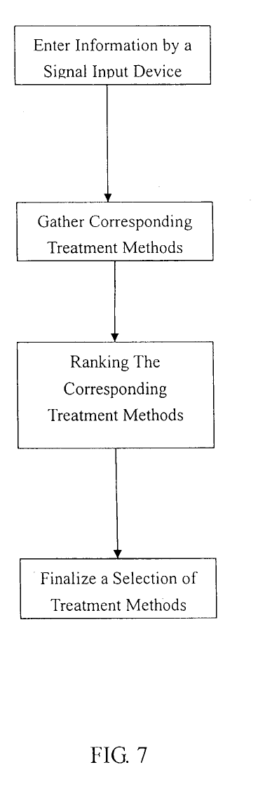

Referring to FIG. 7 of the drawings, a method of using a Chinese medical system according to the first preferred embodiment for diagnosis is illustrated. The method of using the Chinese medical system comprises the steps of:

a. entering information by the signal input device;

b. gathering corresponding treatment methods from the Chinese medical system;

c. ranking the corresponding treatment methods from a set of predetermined factors; and

d. finalizing a selection of the treatment methods.

The information entered may be in the form of typing, or direct data from an audio transmitter, a movement sensor, a thermo-sensor, a pulse sensor. The information may be body weight, body height, age, sex, body temperature, pulse rate, blood pressure, eye appearance, skin appearance, skin tension, nail colour, and any other information.

The set of predetermined factors may be of any kinds, such as a previous successful rate, a time used for successful treatment, and a successful level of previous treatment.

What is claimed is:

1. A medical system comprising:
a signal input device for entering information to said medical system, wherein an input signal is generated in response to the information entered in said signal input device;
a database system communicating with said signal input device and having a diagnostic database, wherein said database system is capable of analyzing and matching said input signal;
a diagnostic output signal generated from said database system after analyzing and matching said input signal of said signal input device;
a responsive system receiving said diagnostic output signal, wherein said responsive system is capable of storing a treatment methods information and analyzing said diagnostic output signal, wherein a responsive signal, adapted to having the treatment methods information, is generated in response to said diagnostic output signal; and
an output device connecting to said responsive system, is adapted for receiving said responsive signal and displaying the treatment methods information.

2. A medical system, as recited in claim 1, wherein said database system and said responsive system is integrally combined, namely a combined system.

3. A medical system, as recited in claim 1, wherein said signal input device is a word inputting device.

4. A medical system, as recited in claim 1, further comprising a language system communicating with said medical system for transforming the information entered and the corresponding treatment methods information to a predetermined language.

5. A medical system, as recited in claim 2, further comprising a language system communicating with said medical system for transforming the information entered and the corresponding treatment methods information to a predetermined language.

6. A central system comprising at least two medical systems as recited in claim 1, wherein said two medical systems is linked together allowing exchange of data between said two medical systems.

7. A central system comprising at least two medical systems as recited in claim 2, wherein said two medical systems is linked together allowing exchange of data between said two medical systems.

8. A medical system, comprising:
a signal input device for entering information to said medical system, wherein an input signal is generated in response to the information entered in said signal input device;
a database system, communicating with said signal input device, having a diagnostic database and comprising a matching analyzer, wherein said matching analyzer matches and analyzes said input signal and said diagnostic database;
a diagnostic output signal generated from said database system in response to a result from said matching analyzer;
a responsive system having an action database having treatment method information, comprising:
a signal transmitter receiving said diagnostic output signal;
a retriever retrieving a corresponding treatment method information from said action database in response to said diagnostic output signal received from said signal transmitter; and
a responsive signal generator receiving the corresponding treatment method information retrieved from said retriever, generating a responsive signal; and
an output device connecting to said responsive system, is adapted for receiving said responsive signal and displaying the corresponding treatment methods information.

9. A medical system, as recited in claim 8, wherein said database system and said responsive system is integrally incorporated together, namely a combined system.

10. A medical system, as recited in claim 8, wherein said diagnostic database and said action database is linked together for sharing.

11. A medical system, as recited in claim 9, wherein said diagnostic database and said action database is linked together for sharing.

12. A medical system, as recited in claim 8, further comprising a language system communicating with said medical system for transforming the information entered and the corresponding treatment methods information to a predetermined language.

13. A medical system, as recited in claim 9, further comprising a language system communicating with said medical system for transforming the information entered and the corresponding treatment methods information to a predetermined language.

14. A medical system, as recited in claim 8, wherein said medical system further comprises a second input device such that inputting information from two different sources is capable of entering simultaneously.

15. A medical system, as recited in claim 9, wherein said medical system further comprises a second input device such that inputting information from two different sources is capable of entering simultaneously.

16. A central system comprising at least two medical systems as recited in claim 8, wherein said two medical systems is linked together allowing exchange of data within said two medical systems.

17. A central system comprising at least two medical systems as recited in claim 9, wherein said two medical systems are linked together allowing exchange of data within said two medical systems.

18. A method of diagnosis by using a medical system as recited in claim 9, comprising the steps of:
(a) obtaining a raw information;
(b) retrieving a predetermined treatment method from the medical system in response to said raw information; and
(c) presenting a resulting treatment method from said above steps.

19. A method of diagnosis, as recited in claim 18, wherein step (b) further retrieves at least one more predetermined treatment method from the medical system in response to said raw information.

20. A method of diagnosis, as recited in claim 19, further comprising the steps of:
(b1) analyzing said predetermined treatment methods; and
(b2) generating a finalized treatment method based on step (b1).
